(19) United States
(12) Patent Application Publication
(10) Pub. No.: US 2024/0106930 A1
(43) Pub. Date: Mar. 28, 2024

(54) SECURE PROCESSING OF SENSITIVE INFORMATION DURING A CALL

(71) Applicant: Sycurio LIMITED, Guildford, Surrey (GB)

(72) Inventor: Thomas Baldwin, Guildford, Surrey (GB)

(21) Appl. No.: 18/030,742

(22) PCT Filed: Oct. 6, 2021
(86) PCT No.: PCT/GB2021/052577

§ 371 Date: Apr. 6, 2023

(30) Foreign Application Priority Data
Oct. 7, 2020 (GB) 2015922.4

(51) Int. Cl. H04M 3/42; H04L 65/1045; H04L 65/65; H04M 7/00

(52) U.S. Cl. CPC H04M 3/42008; H04L 65/1045; H04L 65/65; H04M 7/0078; H04M 2203/6009

(57) ABSTRACT

A method of processing a communication or call between a first entity and a second entity, the method comprising: routing call data between the first entity and the second entity; monitoring for a trigger signal; and upon detecting the trigger signal, routing the call data via a call processor adapted to process the call data for sensitive information received from the first entity.

This invention relates to secure processing of sensitive information during a communication or call, such as a telephone or video call. Aspects relate to a call processing system comprising a call processor and a data switch, in particular one adapted to process signals in dependence on the presence or otherwise of sensitive information within said signals.

It is nowadays common when a payment transaction is undertaken during a telephone call for the process to be agent-assisted, ie. the caller is assisted by an agent acting on behalf of the merchant or service provider. The agent is typically located at a contact or call centre and acts as an intermediary between caller, merchant or service provider and payment provider.

It is preferable for security reasons that the agent does not have access any sensitive information, such as payment details, health information or certain personal identifying information (PII), such as social security or passport information, which are required to be provided by the caller.

An example of a call processing system is described in the applicant's international PCT patent application W02009136163, wherein sensitive information is transmitted by the caller during a telephone call as DTMF tones, and a call processor is located between the caller and the agent which, when operating in a ‘secure mode’, blocks these tones, preventing them from reaching the agent, and processes the encoded sensitive information in order to interact with an external entity.

Implementing agent-assisted call processing systems may lead to high costs and scalability issues due to the hardware and licensing requirements, especially when seeking to integrate them with existing systems. There is therefore a need for more efficient call processing systems, preferably ones which offer similar or additional security advantages. The present invention aims to address these and other issues.

Aspects and embodiments of the invention are set out in the appended claims.

It will be appreciated that some aspects are applicable both to communication via audio (telephone) and also via video, whether implemented via circuit-switching or packet-switching networks.

According to one aspect of the invention there is provided a method of processing a communication or call between a first entity and a second entity, the method comprising: routing call data between the first entity and the second entity; monitoring for a trigger signal; and upon detecting the trigger signal: routing the call data via a call processor adapted to process the call data for sensitive information received from the first entity.

One aspect of the invention lies in the appreciation that every call need not be processed in the same way and instead may be processed according to whether or not the call requires sensitive information to be provided.

Preferably, the method further comprises routing the processed call data absent the sensitive information to the second entity.

Preferably, the call comprises a plurality of data streams and monitoring for a trigger signal comprises mirroring at least one data stream in which a trigger signal may be encoded to a controller.

Preferably, the method further comprises modifying the routing of at least one data stream of the plurality of data streams according to a routing instruction received from the controller detecting the trigger signal.

Preferably, the trigger signal is received from the second entity. The trigger signal may be received from the first entity or a third entity monitoring the call.

Preferably, the trigger signal comprises at least one of: a call identifier, a call parameter or the sensitive information.

Preferably, the method further comprises interacting with an external entity in dependence on the sensitive information.

Preferably, the method further comprises reverting to routing the call data to the second entity once the encoded information has been received from the first entity

According to another aspect of the invention there is provided a call processing system for processing a communication or call between a first entity and a second entity, the system comprising: a data switch, adapted to route call data between the first entity and the second entity; a controller, adapted to monitor for a trigger signal and upon detecting the trigger signal to instruct the data switch to route the call data via a call processor; and a call processor, adapted to process the call data for sensitive information received from the first entity.

Preferably, the call processing system is adapted to route the processed call data absent the sensitive information to the second entity.

Preferably, the call comprises a plurality of data streams and the data switch is adapted to mirror at least one data stream in which a trigger signal may be encoded to the controller.

Preferably, the controller is adapted to issue a routing instruction in response to detecting the trigger signal and the data switch is adapted to modify the routing of at least one data stream of the plurality of data streams in accordance with the routing instruction.

Preferably, the controller is adapted to receive the trigger signal from the second entity.

The controller may be adapted to receive the trigger signal from the first entity or a third entity monitoring the call. The trigger signal may comprise at least one of: a call identifier, a call parameter or the sensitive information.

Preferably, the call processing system is adapted to interact with an external entity in dependence on the sensitive information.

Preferably, the call processing system is further adapted to revert to routing the call data to the second entity once the sensitive information has been received from the first entity.

Preferably, the communication is a SIP call and the data streams comprise SIP, RTP and RTPEVENT streams, preferably wherein the data switch is adapted to mirror the RTP and/or RTPEVENT stream to the controller.

Alternatively, the call is a H.323 VoIP call and the data streams comprise RTP and RTPEVENT streams or H.245 User Input Indication messages.

Generally, the call comprises a plurality of data streams: typically at least one data stream for voice, optionally video, data and at least one data stream for associated call signalling data.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Particular combinations of the various features described and defined in any aspects of the invention can be implemented and/or supplied and/or used independently.

The invention also provides a computer program and a computer program product (and optionally a supporting operating system) comprising software code adapted, when executed on a data processing apparatus, to perform any of the methods described herein, including any or all of their component steps and/or comprises any of the apparatus features described herein. Also provided is a computer readable medium having stored thereon the aforesaid computer program. Also provided is a signal embodying the aforesaid computer program and a method of transmitting such a signal. Furthermore, features implemented in hardware may be implemented in software, and vice versa. Any reference to software and hardware features herein should be construed accordingly.

As used herein, means plus function features may be expressed alternatively in terms of their corresponding structure, such as a suitably programmed processor and associated memory.

The invention extends to methods and/or apparatus substantially as herein described with reference to the accompanying drawings.

Where system elements are shown communicating via a plurality of data ports the skilled person will understand the exact number of data ports is not prescriptive.

The invention will now be described, purely by way of example, with reference to the accompanying drawings, in which:

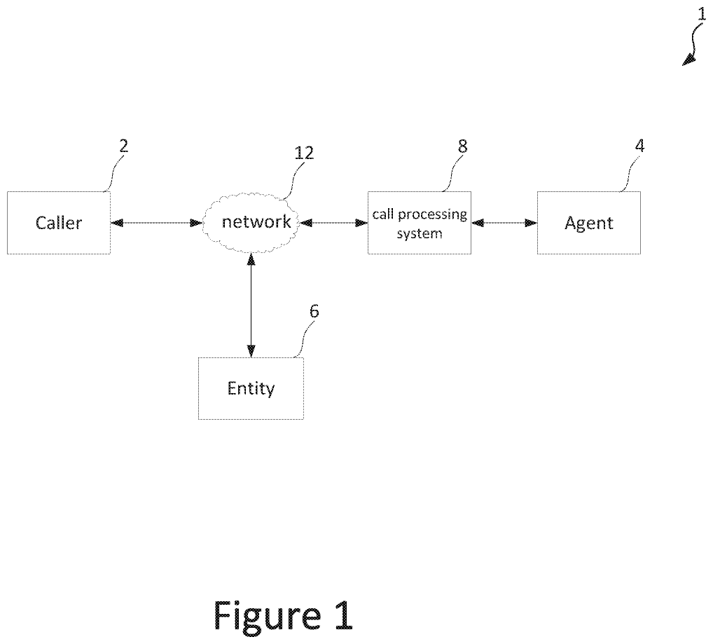

FIG. 1 shows an agent-assisted call in overview;

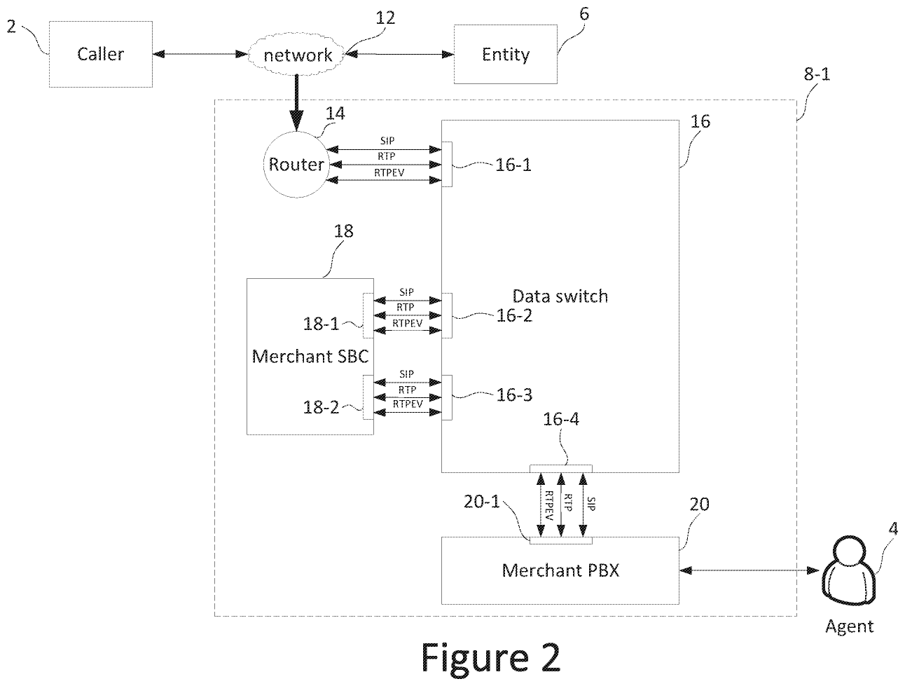

FIG. 2 shows an example of a basic agent-assisted call processing system;

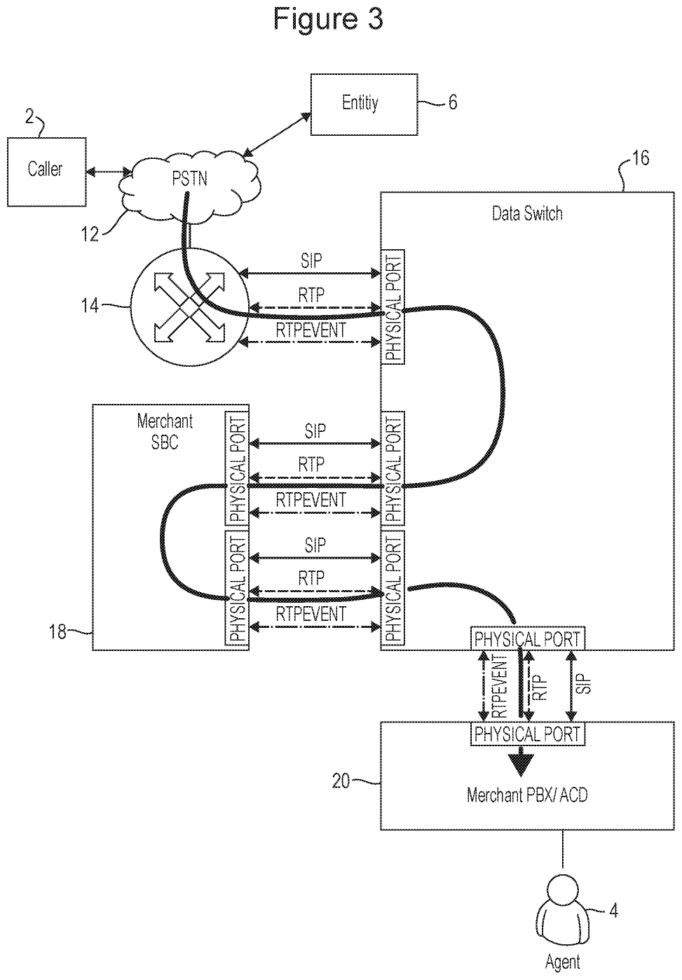

FIG. 3 shows call data flow in the basic agent-assisted call processing system;

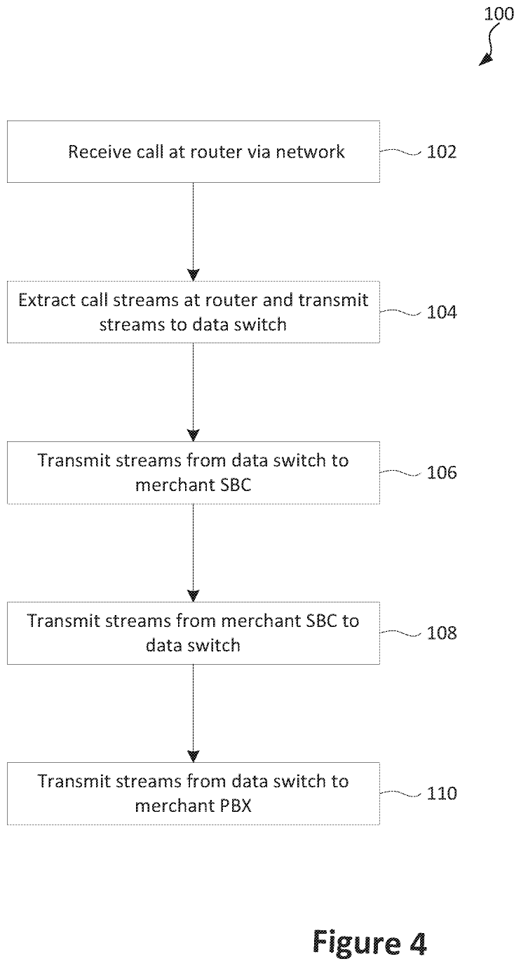

FIG. 4 summarises operation of the basic agent-assisted call processing system;

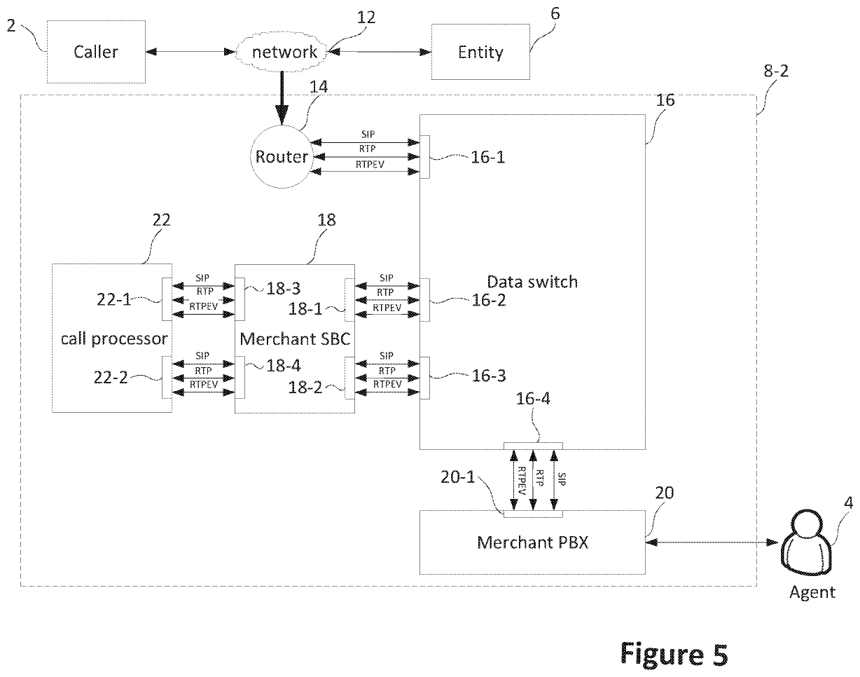

FIG. 5 shows an example of a secure call processing system;

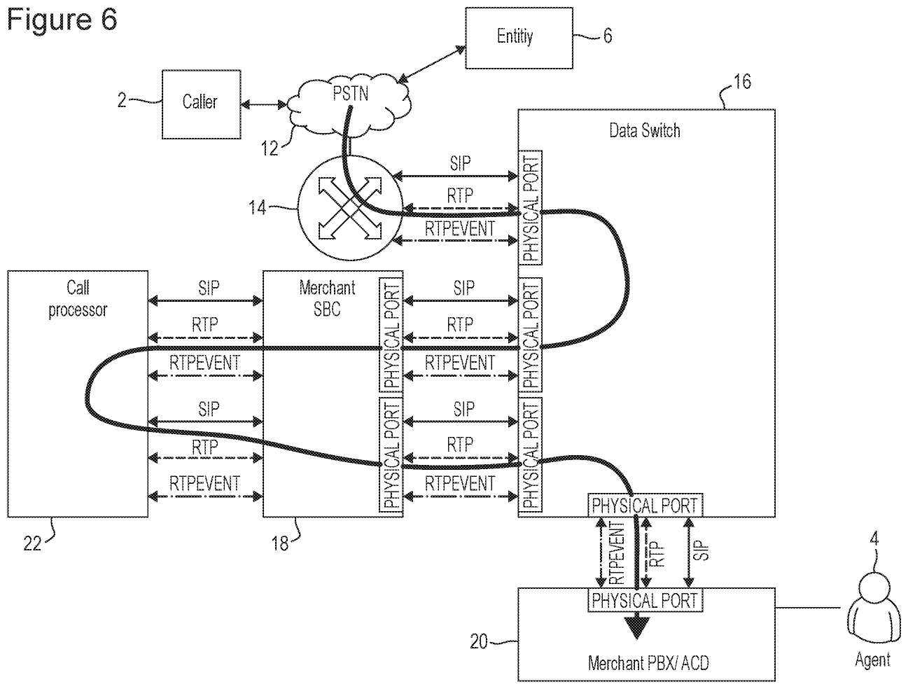

FIG. 6 shows call data flow in the secure call processing system;

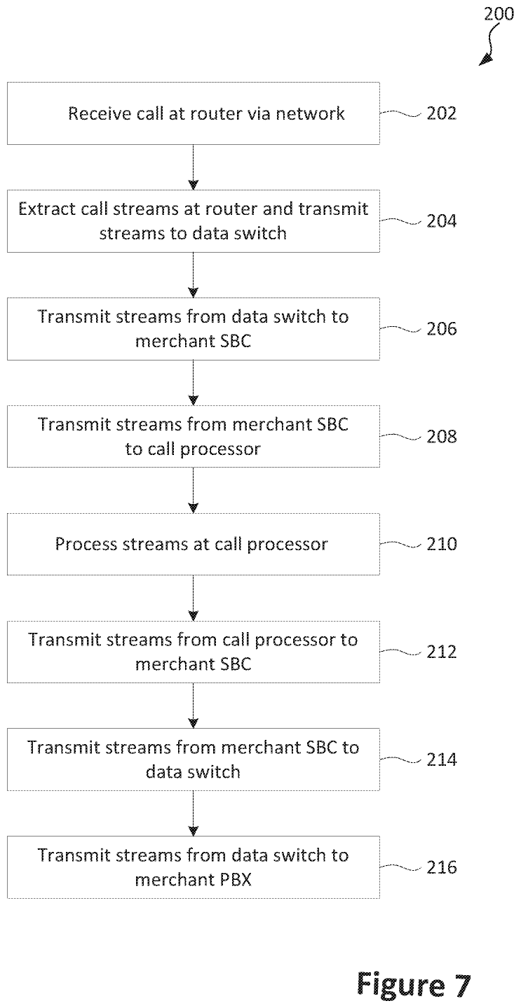

FIG. 7 summarises operation of the secure call processing system;

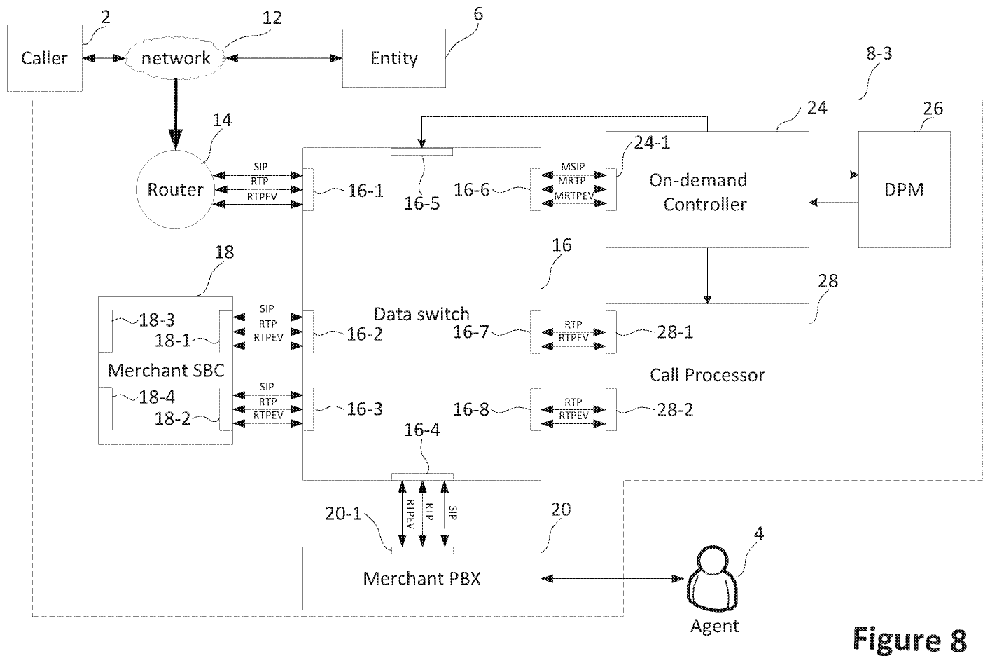

FIG. 8 shows an example of a secure-on-demand call processing system;

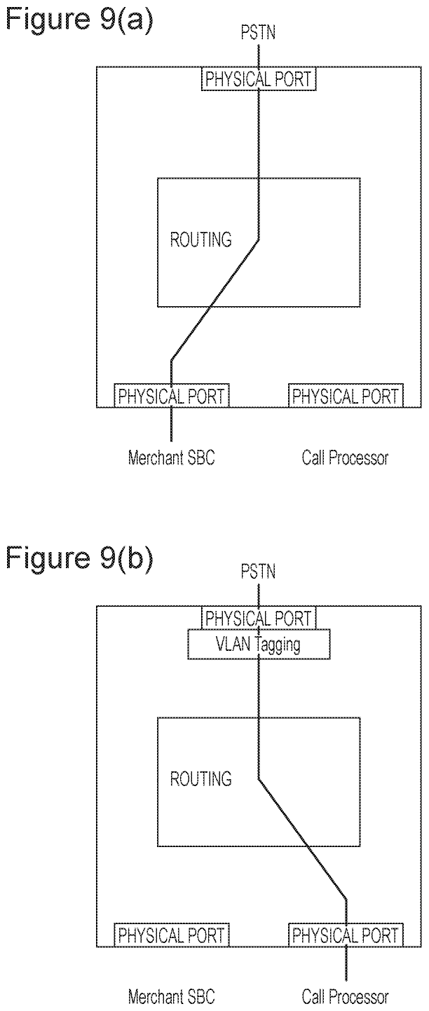

FIG. 9 (a-b) shows dynamic routing in the data switch for secure-on-demand call processing;

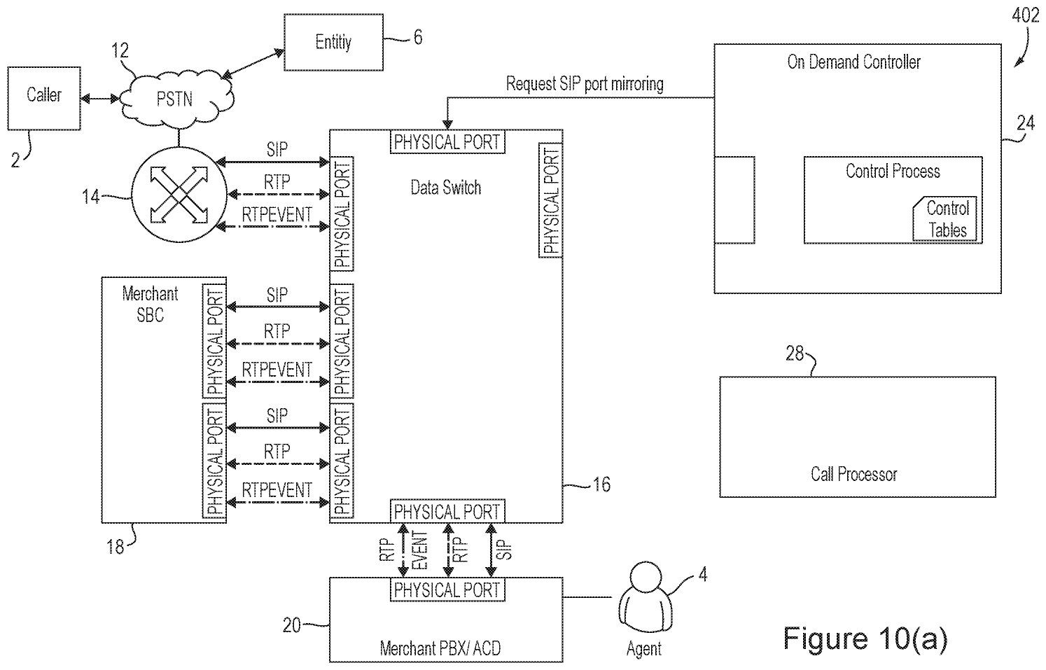

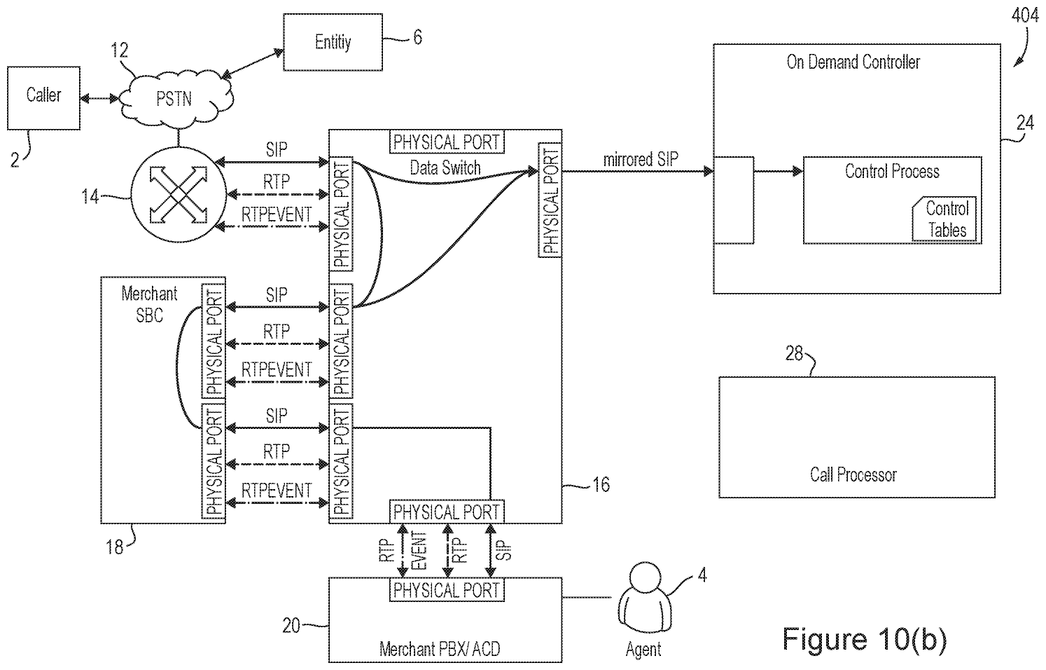

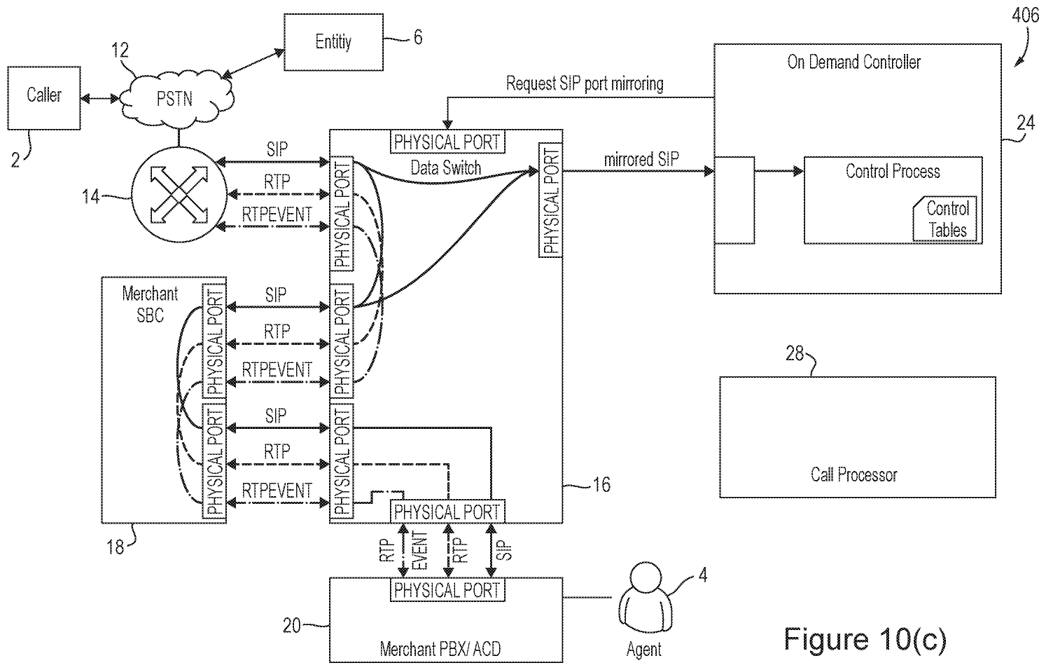

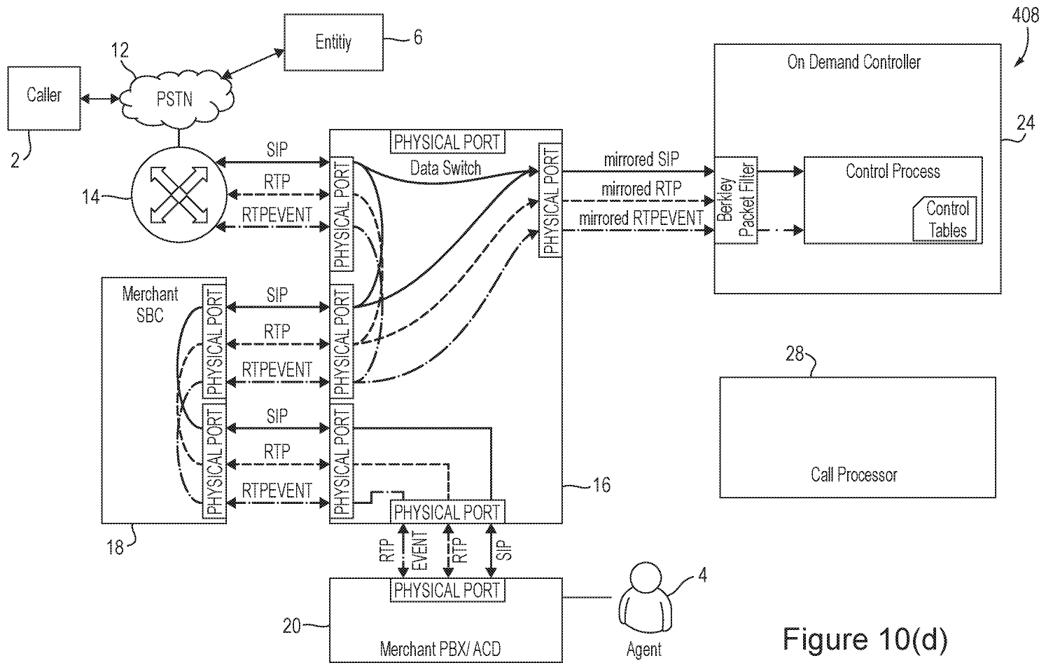

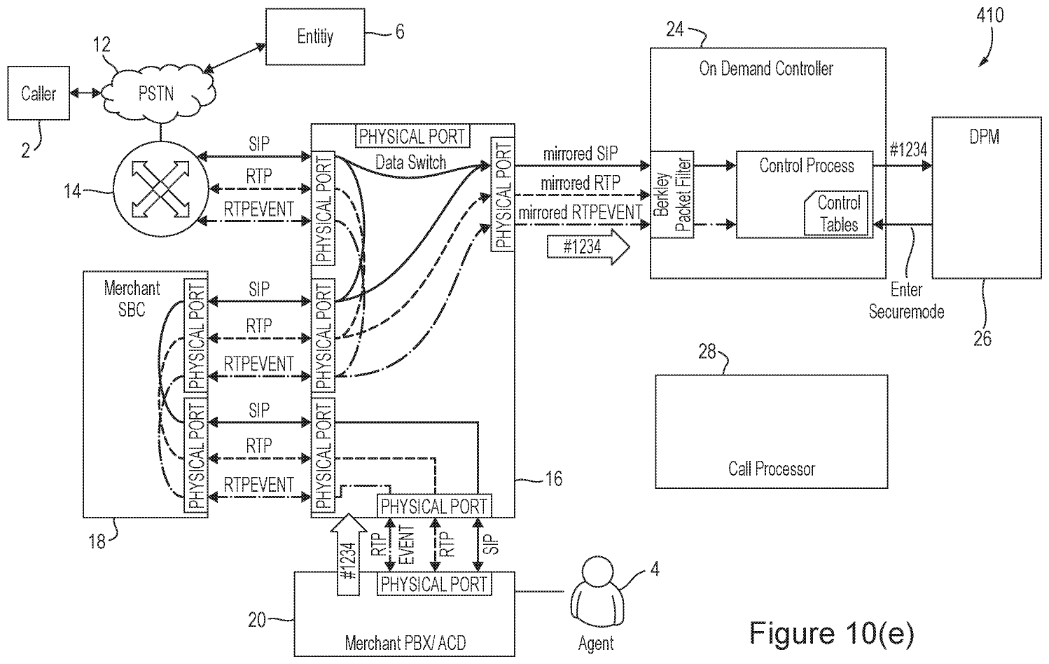

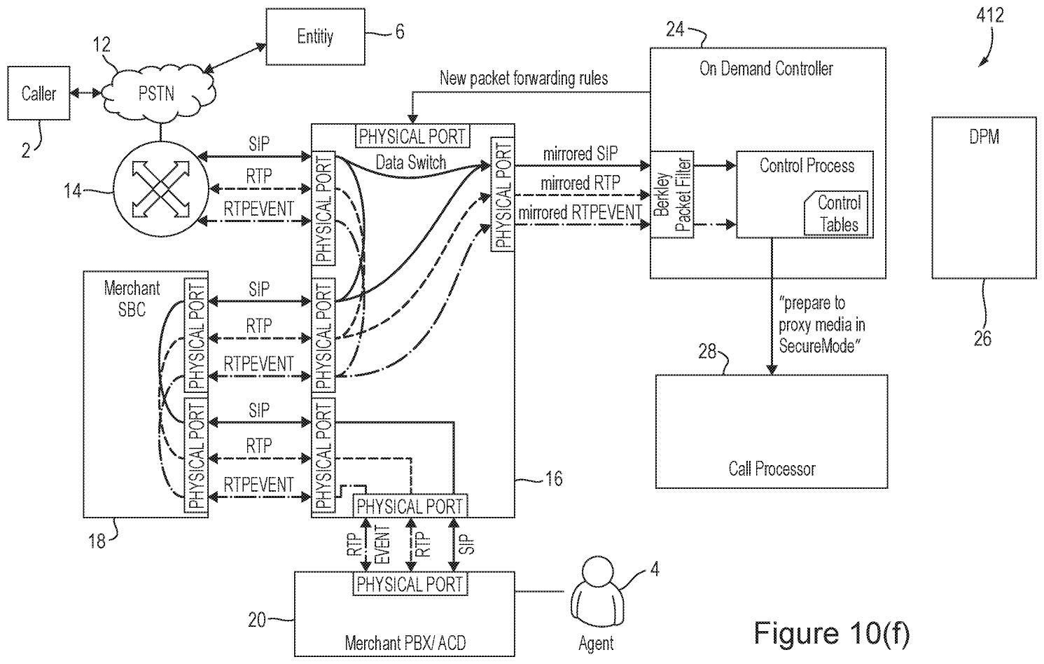

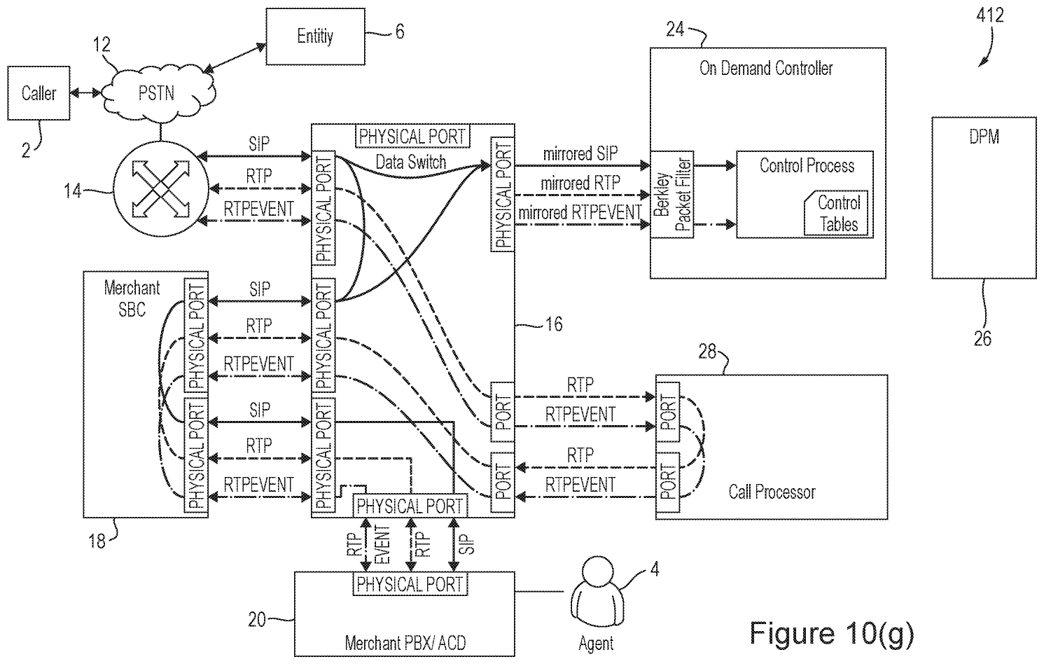

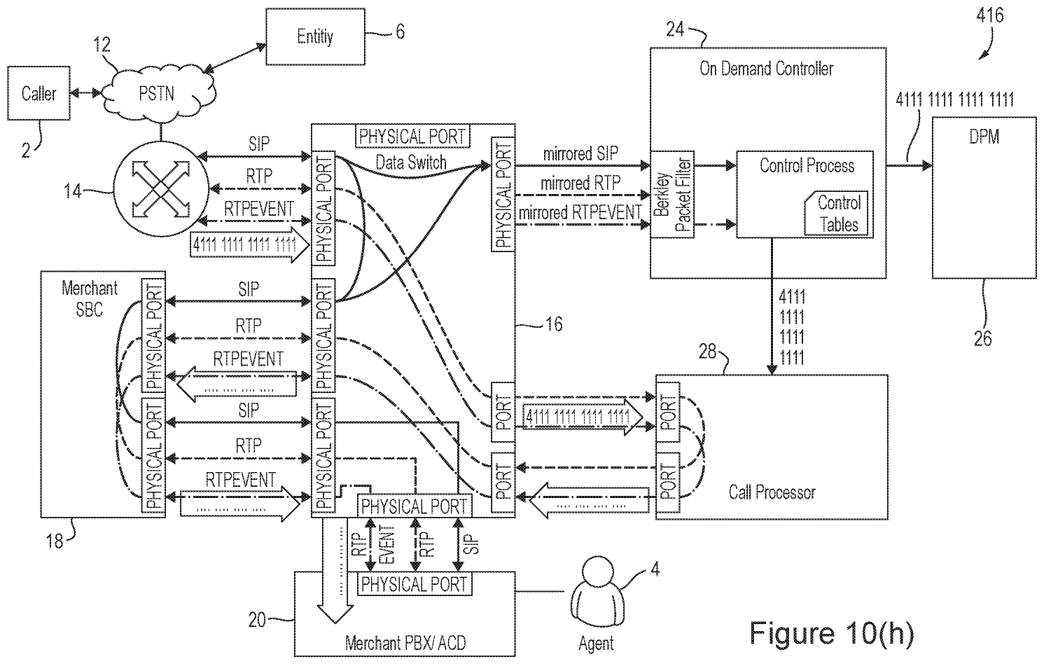

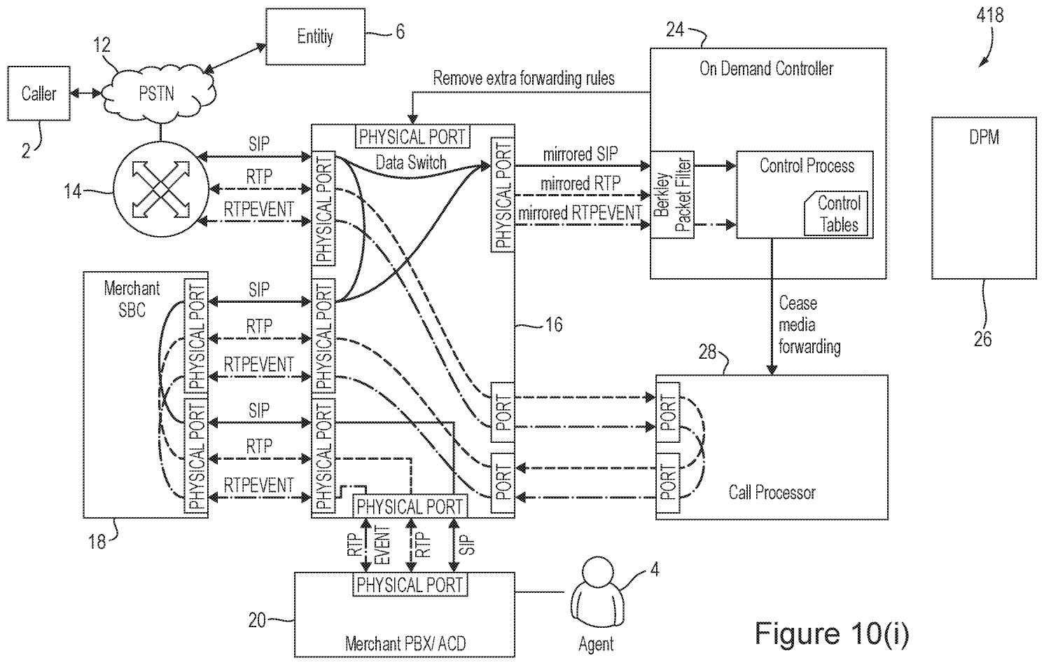

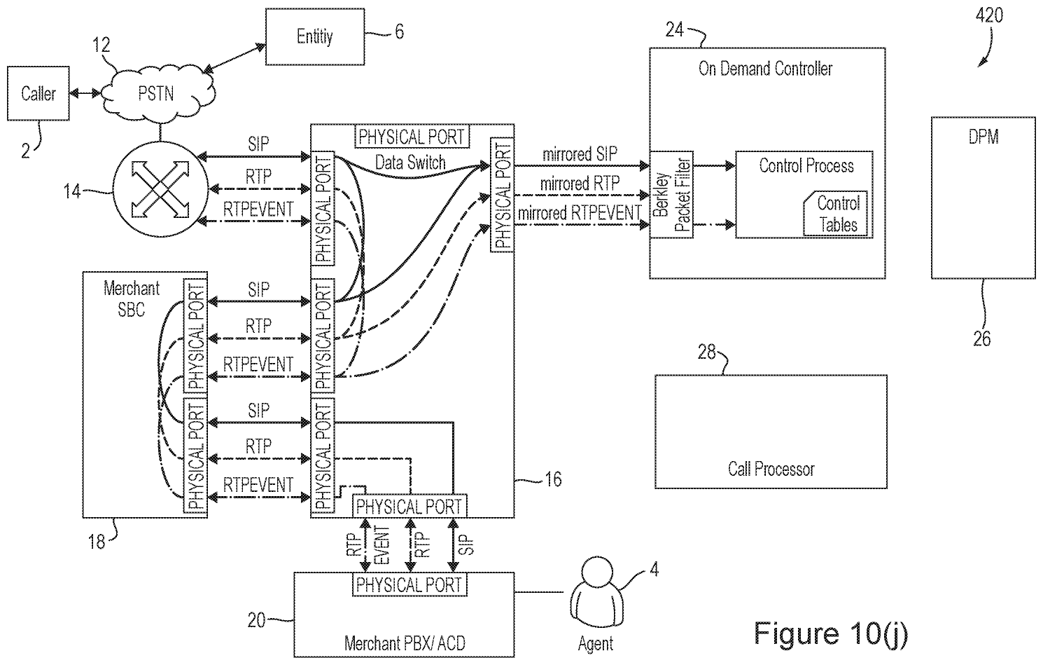

FIG. 10 (a-j) shows operation of and call data flow in the secure-on-demand call processing system; and

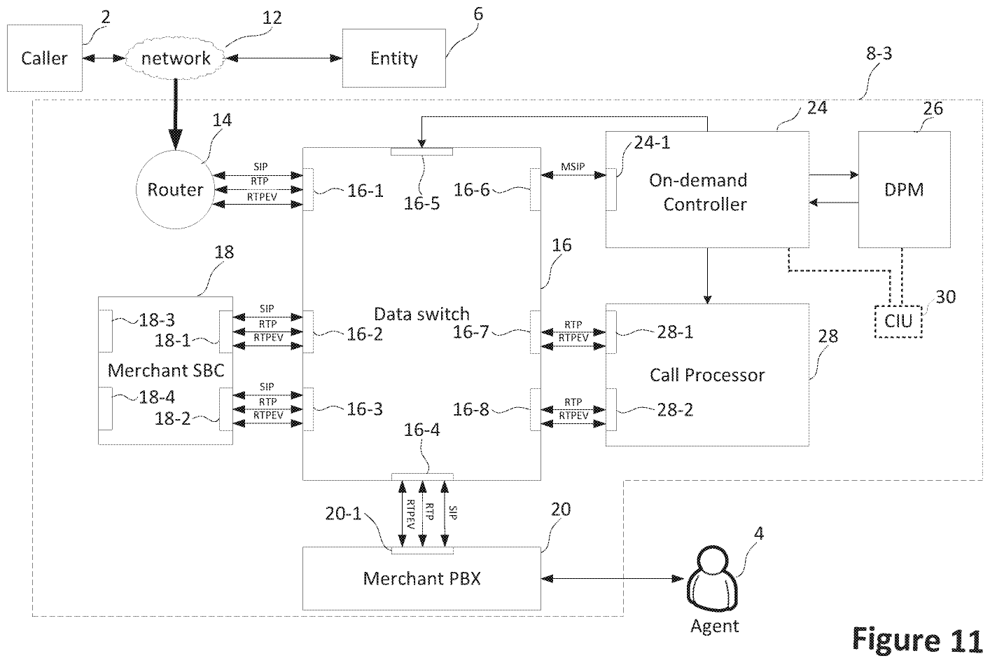

FIG. 11 shows an alternative of a secure call processing system.

### Overview

FIG. 1 shows an agent-assisted call 1 in overview, in which a caller 2 is assisted by an agent 4 when undertaking a transaction, such as payment for a good or service, or more generally when providing sensitive information to an entity 6.

Agent 4 may be an employee of the entity 6. For example, agent 4 may be a store assistant. Alternatively, agent 4 may be related only indirectly or entirely unrelated to the entity 6. For example, agent 4 may employed by a contact centre or call centre engaged by a store or merchant. Agent 4 may be a human or machine.

Entity 6 may be a merchant or service provider. Alternatively, entity 6 may be a payment processor, credit card issuer or a bank, such that entity 6 may be in control of funds relating to the caller 2, wherein preforming the transaction involves the caller 2 authorising the entity 6 to release the funds thereby paying for goods or a service.

Network 12, which facilitates communication between the various parties (caller 2, agent 4, and the entity 6), may, for example, be a public switched telephone network (PSTN), a packet-switched network, a local or area network, a mobile phone network or the internet.

In some embodiments network 12 comprises a plurality of different, interconnected networks, which each may perform one or more parts of the described communication, eg. PSTN for voice traffic, internet for payment traffic etc.

Call processing system 8 is adapted to process a call comprising communication signals transmitted from caller 2 to agent 4. Call processing system 8 may, for example, comprise a telephone system at a call centre, adapted to analyse and route calls to appropriate agents 4.

Call processing system 8 may be adapted to process communications signals in order to prevent sensitive information from being disclosed to the agent.

Further, call processing system 8 may be adapted to identify and process only those communications signals that potentially comprise sensitive information.

Generally, the call may be understood to comprise audio and data communications signals. Other communications and signals may be present, potentially being processed concurrently, eg. a live chat session.

Caller 2, the agent 4, and the entity 6 typically communicate via telephones and/or computers. Data may be entered (and optionally modified or corrected) via a telephone keypad or a keyboard or may be extracted from an audio stream using speech-to-text software. Various devices may be used to receive and/or send information. For example the caller 2 may transmit payment information via a mobile phone and the agent 4 may use a computer to complete a payment using a website of entity 6.

The embodiments described below are shown as being implemented using SIP (session initiation protocol); however, the principles have broader applicability and key concepts may be implemented in other protocols.

### Basic Agent-Assisted Call Processing

FIG. 2 shows an example of a basic agent-assisted call processing system 8-1, adapted to allow caller 2 to be assisted by call centre agent 4 acting on behalf of a merchant when providing sensitive information (eg. payment details) to an entity 6.

Router 14 is adapted to convert communications signals received from the network 12 into a suitable format for further processing by call processing system 8-1, for example, by converting analogue signals into digital or from one protocol into another.

In some embodiments router 14 is not required and is therefore not present.

Three data streams are present for SIP communications:
SIP stream, comprising information relating to the initiation, maintenance, and termination of a call, eg. a call identifier, call start and end times
RTP (real-time transport protocol) stream, comprising audio information, eg. relating to the words being spoken by the caller 2. Typically, this stream contains all the audio data transmitted by caller 2.
RTPEVENT/RTPEV (real-time transport event) stream, comprising “events” carried in the signal, eg. equivalent to tone signals such as dual-tone multi-frequency (DTMF) signals.

Each data stream is directional, in the sense that one RTP stream conveys the speech of caller 2 to agent 4; a second RTP stream (in the reverse direction) conveys the speech of agent 4 to caller 2

In some embodiments, the RTPEV stream contains DTMF tone data extracted from the RTP audio data of the call. Typically, this tone data is extracted upstream in the PSTN, closer to the caller device which generates the tones. The DTMF tones present in the RTP audio stream would normally be removed. Imperfect removal gives rise to the phenomenon of “DTMF bleed” as addressed in the applicant's international PCT patent application W02018172771.

If the call is purely digital ‘DTMF’ signals (or equivalents) are solely in the RTPEVENT stream.

Generally, the call comprises call identifier and data/media streams.

Merchant PBX/ACD (private branch exchange/automatic call distributor) 20, provides call routing within the merchant network, transferring the call to an appropriate agent 4, thereby allowing the agent 4 to communicate with the caller 2. Merchant PBX 20 may also provide for additional functionality, for example call recording for security and/or training purposes.

In order to provide additional security for the merchant network, merchant session border controller (SBC) 18 is provided and is adapted to protect the merchant network of the merchant from malicious actions such as denial-of-service (DoS) attacks. Merchant SBC 18 may, for example, examine the data stream(s) to detect a call identifier and from this determine whether this identifier relates to a legitimate call.

Merchant SBC 18 may also perform additional tasks with the data streams, for example, “topology hiding” (remapping network addresses such that an external entity cannot infer anything about the arrangement of the network in the contact centre), transcoding audio from one format to another, providing copies of the media streams to call recording devices etc.

Merchant SBC 18 may also assist with routing calls within the merchant network, for example, choosing amongst a number of PSTN connections for outbound calls on the basis of call cost, handling failover between multiple PSTN connections for availability purposes etc.

However, SBCs often have few physical network interfaces or ports. Many of these are taken up by multiple connections from the PSTN, cross-connections for high availability SBC pairs, administrative connections, and likely multiple pieces of equipment comprising the Merchant PBX.

Data switch 16 is therefore provided to function as a “port expander” in order to allow for additional equipment to be connected to the SBC than would otherwise be possible. Data switches are usually equipped with a large number of data ports hence the cost per port is considerably less than were data ports to be provided on an SBC, if it were possible to have additional ports on the SBC at all.

Data switch 16 is adapted to route the data streams between the other components of the call processing system 8-1 and comprises a plurality of switch interfaces 16, including:
switch interface 16-1, for communicating with the network (via router 14)
switch interfaces 16-2, 16-3 for communicating with merchant SBC 18 via the merchant SBC interfaces 18-1, 18-2
switch interface 16-4, for communicating with the merchant PBX 20 via merchant PBX interface 20-1

FIG. 3 shows call data flow in the basic agent-assisted call processing system, from network 12 via router 14, data switch 16, merchant SBC 18 and back via data switch 16 to merchant PBX 20.

FIG. 4 summarises operation of the basic agent-assisted call processing system, according to the following steps S:
S1. At 102, a call is received at the router 14 via the network 12.
S2. At 104, the router 14 processes the call to extract the SIP/RTP/RTPEV data streams and transmits them to the data switch 16.
S3. At 106, the data switch 16 forwards the data streams to the merchant SBC 18.
S4. At 108, the merchant SBC 18 analyses the data streams, takes any security measures as appropriate and, if all is well, transmits the data streams back to the data switch 16.
S5. At 110, the data switch 16 transmits the data streams to the merchant PBX 20.

In order to complete the transaction, the caller 2 transmits sensitive (payment) information to the agent 4. This may be done verbally, with the caller speaking the payment information aloud, or electronically, say by the caller entering the payment information via a telephone keypad. The payment information is received by the agent 4 and can then be used to complete the transaction by the agent communicating with the entity 6.

Evidently, a problem with the basic agent-assisted call processing system 8-1 as described above is that the agent is privy to the sensitive payment information provided by the caller and potentially able to use it for illicit purposes. Likewise, any call recording may also pose a security risk or impose a legal compliance burden eg. for GDPR.

As mentioned above, one approach to mitigate this is provided by W02009136163, as described in the following.

### Secure Call Processing

FIG. 5 shows an example of a secure call processing system 8-2, based on the basic agent-assisted call processing system 8-1 described above, further comprising a call processor 22 similar to those described in W02009136163.

Call processor 22 may be operable in two modes: ‘normal mode’ in which both voice and data signals are relayed without modification, and ‘safe mode’ in which voice signals may (in order to maintain verbal communication between caller and agent) or may not be relayed whereas data signals are blocked. In this way, sensitive information received from the caller encoded in the data signals (eg. as DTMF tones which may be easily detected within an audio stream since they comprise known frequencies) is prevented from reaching the agent when call processor 22 is in ‘safe mode’.

Use of a call processor with normal/safe modes may enable the use of DTMF-driven menu systems at those times during a call when sensitive information is not being transmitted.

‘Safe mode’ may be activated (and deactivated) by means of a ‘secure mode’ trigger signal sent by either the agent 4 or the caller 2, e.g. key press ‘*’, that is present in the RTPEVENT stream or sent as a computer telephony integration (CTI) signal.

In some embodiments call processor 22 itself determines from the received voice and data signals that sensitive information is being—or is about to be—transmitted. This determination may comprise detecting one or more of:
presence of data signals, such as DTMF tones
a particular pattern of data signals, such as may represent the initial digits of a credit card or social security number
specific information encoded in the data signals, for example the identifying code of a payment card issuer
action by the caller 2 or agent 4, eg. opening a browser window or payment application

Even though ‘secure mode’ of the call processor 22 may only be activated during a call, call processing system 8-2 nevertheless may require each call to be routed via the call processor 22, since it is not always possible to tell ahead of time—that is, before the call is processed by the call processor 22—whether a particular call may involve sensitive information.

In this embodiment, call processor 22 is provided as an adjunct to merchant SBC 18, such that all call data streams are routed through it via complementary data interfaces 18-3, 18-4 of merchant SBC 18 and 22-1, 22-2 of call processor 22. The processed data streams (absent sensitive information) are then returned via the data switch 16 to the merchant PBX 20 and thence to the agent 4.

In some real-world implementations, the call processor 22 may be directly connected to the data switch 16, simply due to the lack of ports on the SBC discussed above; however, the logical path of the call is as shown in FIG. 5.

Call processor 22, if required, then interacts with an appropriate external entity 6 to provide the sensitive information to complete the transaction.

The interaction with the external entity 6 may also involve input from the agent 4. For example, a purchase transaction may require agent 4 to provide a price, optionally to be confirmed by the caller 2, in respect of which caller 2 provides the payment details.

When operating in ‘safe mode’ call processor 22 either blocks the RTPEVENT stream entirely or removes or masks (for example by replacing or overwriting) the sensitive information encoded in the RTPEVENT stream before the call data streams are relayed, via the merchant SBC 18 and data switch 16, to the merchant PBX 20 and thence to the agent 4.

Call processor 22 may entirely remove sensitive information from the RTPEVENT stream, or replace the sensitive information with say an indicator that data has been entered and/or the amount of sensitive information provided.

Call processor 22 may also increase security further by removing any ‘DTMF bleed’ present in the audio of the RTP stream, for example in accordance with the methods described in W02018172771.

FIG. 6 shows call data flow in the secure call processing system, from network 12 via router 14, data switch 16, merchant SBC 18, call processor 22 and back via merchant SBC 18 and data switch 16 to merchant PBX 20.

FIG. 7 summarises operation of the secure call processing system, according to the following steps S:
S1. At 202, router 14 receives a call from caller 2 via the network 12.
S2. At 204, the router 14 processes the call to extract the SIP/RTP/RTPEV data streams, and transmits them to the data switch 16.
S3. At 206, the data switch 16 transmits the data streams to the merchant SBC 18.
S4. At 208, merchant SBC 18 analyses the data streams, takes any security measures as appropriate and, if all is well, transmits the data streams to the call processor 22.
S5. At 210, call processor 22 processes the received call data streams, blocking the transmission of any sensitive information to the agent 4. More generally, call processor 22 may block call any stream from passing from the caller 2 to the agent 4 and vice versa
S6. At 212, the streams are transmitted from the call processor 22 to the merchant SBC 18.
S7. At 214, the streams are transmitted from the merchant SBC 18 to the data switch 16.
S8. At 216, the streams are transmitted from the data switch 16 to the merchant PBX 20.

In order to complete the transaction, call processor 22 interacts with and transmits the sensitive (payment) information to the entity 6. Alternatively, call processor 22 interacts with a merchant payment or sensitive information handling system which in turn interacts with entity 6.

This enables the caller 2 to communicate with an agent 4 of the merchant during a transaction without sensitive information entered by the caller 2 passing to the agent 4. The agent 4 may not be aware of, or in control of, the call processor 22.

Call processor 22 may be integrated into existing call processing systems with little modification, only requiring changing the operation of the merchant SBC 18 so as to forward all incoming calls to the call processor 22 and to receive processed call data streams in return.

Call processor 22 and merchant SBC 18 may be implemented as separate components. This enables call processor 22 to be provided by a third party.

However, requiring all calls to be processed by the call processor 22, whether or not they involve the transfer of sensitive information, has in some cases certain disadvantages:
use of additional network ports of the merchant SBC 18 may be required
some clients may dislike having all calls processed by the external party providing the call processor 22
call processor 22 may be a single point of failure for all calls
additional licence fees may be required as the merchant SBC 18 essentially has to process two incoming calls for each caller-agent interaction, one from the caller 2 and another from the call processor 22

One approach to mitigate this is provided by making use of the ability of some data switches 35 to be (re-) configured on demand, so-called software-defined networking (SDN), as described in the following.

### Secure-On-Demand Call Processing

FIG. 8 shows an example of a secure-on-demand call processing system 8-3, based on the secure call processing system 8-2 described above with further modifications.

Call processor 28 performs a similar function to that of call processor 22 in previous call processing system 8-2, being arranged to receive call data comprising sensitive information and to process the call data and to prevent the sensitive information reaching the agent 4.

However, unlike in previous call processing system 8-2, where call processor 22 is arranged in series with the merchant SBC 18 such that all call data is routed via the call processor 22, in call processing system 8-3 call processor 28 is instead separately and directly connected to the data switch 16 (via respective data ports 28-1, 28-2 and 16-7, 16-8).

Arranging the call processor 28 to communicate directly with the data switch 16 enables the call processor 28 to be used with existing systems with minimal modification. In particular, merchant SBC 18 may operate without any awareness of call processor 28. Generally, this arrangement allows call processor system 8-3 to be agnostic as to the particular merchant SBC 18.

Furthermore, it allows for use of advanced routing functions of data switch 16, specifically:
port mirroring, whereby a copy of data received at a first port is provided at a second port, thereby allowing remote monitoring of received data
dynamic routing, wherein packet forwarding rules may be updated, preferably in real-time, thereby allowing data paths to be modified on demand.

This allows for call processing system 8-3 to be transitioned into and out of a ‘secure mode’ by modifying the behaviour of data switch 16 as required and may allow for call processor 28 to serve in a less active, more passive sense, being in-line for only for the duration of the ‘secure mode’ than call processor 22 in previous call processing system 8-2.

Modifying an existing call processing system - including one based on call processing system 8-2—may therefore require only provision of a router 14 and connections to the other system components described below.

This may also increase system resilience as failure of call processor 28 would likely not prevent call processing system 8-3 handling calls per se, only limiting the use of ‘secure mode’.

This arrangement may obviate the need for additional licence fees for each call as merchant SBC 18 only has to handle a single incoming call for each caller-agent interaction.

This may reduce also the need for as large of number of call processors 28 as would otherwise be needed in order to handle large call volumes, as likely only a small number of calls would require ‘secure mode’ at any one time.

Control of the data switch 16 is via an on-demand controller (ODC) 24, which is likewise separately connected to the data switch 16 (via respective data ports 24-1, 16-5 and 16-6) and also to the call processor 28.

ODC 24 is adapted to request and receive from data switch 16 a mirror or read-only copy of sundry SIP call data streams (SIP, RTP, and RTPEVENT streams) and, if ‘secure mode’ determined to be required, to instruct data switch 16 to re-route call data streams to allow processing by call processor 28. ODC 24 may therefore require administrator level or equivalent access privileges to data switch 16.

In this way, calls that contain sensitive information may be handled differently from those that do not contain sensitive information.

The mirroring requests and data stream / port mirroring may be implemented for example by making use of Protocol Oblivious Forwarding (POF), such as described in OpenFlow v2.0, or similar.

POF allows the data switch 16 to discriminate between RTP and RTPEVENT packets, and send only the RTPEVENT packets (and not the RTP packets) to the ODC 24. This is beneficial since the number of RTP packets is huge compared to the number of RTPEVENT packets. Use of POF therefore reduces the bandwidth required at ODC port 24-1, and also reduces the computational load on ODC 24.

If POF is not available, so that only simple port mirroring can be performed, then the use of the Berkley Packet Filter is suggested below as an efficient way of filtering out the unwanted RTP packets at the earliest possible opportunity after they have entered the ODC 24.

Suitable data switches may include certain models produced by Cisco (3850 series) and HP (E3800 series) and similar.

Preferably, the RTP and/or RTPEVENT streams are re-routed, preferably only the RTPEVENT streams is re-routed; the routes of the SIP streams remain unchanged.

ODC 24 may comprise a Berkley packet filter or equivalent at ODC interface 24-1 to allow it to operate as a network device in ‘promiscuous mode’, ie. able to accept network packets irrespective of the addressee indicated in the packet header.

As ODC 24 is not in-line with the merchant SBC 18 the latter operates in the same way whether or not the ODC 24 is in use, so calls that do not contain sensitive information proceed as they would if the ODC 24 were not present. This also ensures that operation of the call processing system 8-3 can continue even if there is a failure of ODC 24.

Data processing module (DPM) 26 is provided and adapted to communicate with the ODC 24 and, in combination with the ODC 24, to process said streams to determine the presence of a ‘secure mode’ trigger signal and/or sensitive information within call data streams.

In some embodiments, DPM 26 is also adapted to store sensitive information that is extracted from the call streams.

In some embodiments, the functions of ODC 24 and DPM 26 are provided by a single unit. More generally, It will be appreciated that various components of call processing system 8-3 may be combined. For example, the functions of any two or more of ODC 24, DPM 26, and call processor 28 may be combined in a single component.

ODC 24 and DPM 26 may be implemented one or more as general purpose computers.

Call processor 28 may be provided by a third party, as may ODC 24 and/or DPM 26. Existing units may also be repurposed with minimal, if any, modification. In particular, the system design is sufficiently decoupled that the SBC 18 is unaware of the actions of the call processor 28 and ODC 24.

FIG. 9 (a & b) shows dynamic routing in the data switch for secure-on-demand call processing.

Generally, routing behaviour of the data switch 16 is determined by stored routing tables which indicate the path each data packet or stream is to take in dependence on the packet header. Network protocols such as OpenFlow allow VLAN encapsulation (tagging) on ingress, on a per traffic flow (IP, port, protocol) basis. Incoming data may therefore be tagged in order to determine from the routing tables which routing path is to be used.

FIG. 9(a) shows a first or default state ('normal mode') wherein data switch 16 forwards and routes data packets as usual, based on IP/MAC addresses. A data path is provided by data switch 16 from router 14 to merchant SBC 18.

FIG. 9(b) shows a second state ('secure mode') wherein data switch 16 routes data packets from router 14 to call processor 28 - and thereafter from call processor 28 to the merchant SBC 18. Call processor 28 has been instructed by ODC 24 to adopt (spoof) the IP address of merchant SBC 18 (albeit in a different VLAN), so that it receives data packets from the router 14 intended for merchant SBC 18. Call processor 28 may also spoof the IP address of the router 14, so that the merchant SBC 18 does not identify the presence of the call processor 28. Data switch 16 now routes traffic according to the new VLAN tag to call processor 28.

FIG. 10 (a-j) shows operation of and call data flow in the secure-on-demand call processing system, with FIG. 10 (a-d) showing the set-up of call monitoring, to allow for identification of calls and detection of the triggering of ‘secure mode’, and FIG. 10 (e-i) showing triggering, operation of and exit from ‘secure mode’.

FIG. 10 (a) shows, at 402, ODC 24 sending a request to data switch 16 for mirroring of SIP data. Preferably, the request is for mirroring of all SIP traffic between network 12 and merchant PBX 20, ie. all incoming traffic received from caller(s) 2 via the network 12 and destined (via merchant SBC 18) for the merchant PBX 20 and agent(s) 4, and vice versa.

Alternatively, the request from ODC 24 may be for a subset of SIP traffic. The SIP stream contains information about a call that can be used to determine, for example, the origin of the call and the identity of the caller, and may therefore be used to determine which calls may involve sensitive information, eg. those to a purchasing department.

Typically the initial request is sent before any calls are received so that monitoring is in place for all subsequent calls. The request may be sent before a particular call or set of calls is received or during a call.

FIG. 10 (b) shows, at 404, data switch 16 providing the requested mirrored SIP data, originating from network 14 and merchant PBX 20 (hence agent 4), to the ODC 24.

As shown, the original path of the call originates from network 12, proceeds via router 14, data switch 16, merchant SBC 18, and back via data switch 16 to merchant PBX 20.

Each SIP call has a unique identifier which allows the ODC 24 to identify each call between caller 2 and agent 4. The SIP data stream alone will identify all calls and end-points, but does not necessarily provide any information regarding any sensitive information present in the RTPEVENT stream. The identifier may therefore be forwarded to other components of the call processing system 8-3 such as the merchant PBX 20 or DPM 26 without security risk.

Alternatively, in a similar way as described above, the request from ODC 24 for RTP and/or RTPEVENT mirroring may be only for a subset of SIP traffic, eg. those to a purchasing department.

FIG. 10 (c) shows, at 406, ODC 24 sending a request to data switch 16 for mirroring of RTP (audio) and RTPEVENT data streams received from the merchant PBX 20, ie. from the agent 4.

Alternatively, where sensitive information may be determined solely using the RTPEVENT stream, ODC 24 may request mirroring of only the RTPEVENT stream. This may address merchant concerns with RTP (audio) data being mirrored to ODC 24 which may be provided by an external party.

As a further alternative, if sensitive information is transmitted solely as DTMF tones as part of the audio, such that there is no RTPEVENT stream, the ODC 24 may request mirroring of only the RTP stream and determine sensitive information solely using the RTP stream. This would however likely require the ODC 24 to constantly monitor the audio to determine whether a DTMF digit is being transmitted, which would represent a massive load for the ODC 24.

FIG. 10 (d) shows, at 408, ODC 24 receiving mirrored streams for all SIP and agent RTP and/or RTPEVENT streams from the data switch 16.

ODC 24 is now acting as a passive monitor, being aware of all calls and of all agent-emitted RTPEVENTs such as might trigger ‘secure mode’ but is not in the call flow as such.

In some embodiments, to facilitate ‘secure mode’ being triggered by caller 2, ODC 24 requests and receives mirrored RTP and/or RTPEVENT streams from caller 2.

FIG. 10 (e) shows, at 410, a ‘secure mode’ request or trigger signal code #1234 originating from agent 4 and sent via the RTPEVENT data stream from merchant PBX 20 being mirrored to ODC 24, which detects the presence of code from the agent 4 and in turn forwards the code to DPM 26.

DPM 26 determines that the received code comprises a ‘secure mode’ trigger signal and instructs the ODC 24 accordingly to bring the call processor 28 online.

Typically, agent 4 sends the ‘secure mode’ request during a call, immediately before requesting the caller 2 enter sensitive information. Alternatively, the request may come from the caller 2.

In some embodiments, the mirrored streams are evaluated, for example by ODC 24 and/or DPM 26, to determine whether ‘secure mode’ is required and may be activated without requiring an explicit trigger signal to be sent by agent or caller.

FIG. 10 (f) shows, at 412, ODC 24 transmitting i) a ‘secure mode’ initiation signal to the call processor 28, instructing it to prepare to handle or proxy the media path for the call, and ii) new packet forwarding rules to the data switch 16, so that certain data streams received by the data switch 16 from the router 14 are instead to be routed to call processor 28 before onwards transmission to the merchant PBX 20—and sensitive information from the caller is thus prevented from reaching the agent.

Hence, in ‘normal mode’ data switch 16 is configured to transmit data streams received from router 14 via the merchant SBC 18 to merchant PBX 20; whereas, in ‘safe mode’, data switch 16 is configured to transmit the data streams received from router 14 instead to the call processor 28 which subsequently transmits the data streams via the merchant SBC 18 to 25 merchant PBX 20.

Merchant SBC 18 and merchant PBX 20 see the same call without interruption and are oblivious to the changes in call routing.

FIG. 10 (g) shows, at 414, data switch 16 forwarding the RTP and RTPEVENT streams (relating to a call received from caller 2 over the network 12) from router 14 to call processor 28 in accordance with the new packet forwarding rules. The media path for the call from caller 2 to agent 4 is now routed via the call processor 28 then, via the data switch 16, to the merchant SBC 18 and, again via the data switch 16, to merchant PBX 20, and vice versa for the call from agent to caller. Call processor 28 therefore acts as a media proxy. The path of the SIP streams remains unchanged. As shown, in this embodiment mirroring by data switch 16 of RTP and/or RTPEVENT streams to ODC 24 continues.

In some embodiments, the RTP (audio) stream is blocked from reaching the call processor 28 during some or all of ‘secure mode’ so that no audio from caller 2 is transmitted to agent 4. This may be done by filtering the RTP (audio) and RTPEVENT (DTMF) streams, which follow same path, by type identified from the packet header so that only the RTPEVENT stream is forwarded to call processor 28. In some embodiments this filtering is performed in the data switch 16.

Call processor 28 may also provide ‘bleed removal’, as described above in W02018172771, since it is receiving the RTP stream, it may modify individual packets within that stream in order to remove DTMF bleed without affecting the speech path between agent and caller.

FIG. 10 (h) shows, at 416, sensitive information input by the caller 2, encoded in the RTPEVENT data stream, being received from router 14 by the data switch 16 and forwarded to call processor 28.

The RTPEVENT stream typically comprises a string of digits that relate to the caller input data. For example, as shown, when caller 2 enters a string ‘4111 111 111 111’ on a telephone keypad, this string appears encoded in the RTPEVENT stream.

In some embodiments call processor 28 processes the received RTPEVENT stream, extracts the caller input data comprising the encoded sensitive information, and transmits the data to the ODC 24 which forwards it to DPM 26. DPM 26 then processes the received data to extract the sensitive information.

In other embodiments call processor 28 processes the received RTPEVENT stream, extracts the encoded sensitive information, and transmits the sensitive information to the ODC 24 which forwards it to DPM 26.

If required, DPM 26 then interacts with an appropriate external entity 6 to provide the sensitive information to complete the transaction.

Alternatively, call processor 28 interacts with an appropriate external entity 6 to provide the sensitive information (if necessary, having first received the sensitive information from the DPM 26) to complete the transaction.

Call processor 28 also forwards, via the data switch 16 and merchant SBC 18, the RTP (audio) stream and a modified RTPEVENT stream to merchant PBX 20, wherein the sensitive information encoded in the RTPEVENT stream is removed or masked, for example by deleting, replacing or overwriting.

In some embodiments, call processor 28 replaces the sensitive information encoded in the RTPEVENT stream in dependence on the sensitive information received. For example:
an indicator may be provided to indicate that sensitive data has been received.
each entered digit may be replaced with a digit that depends on an evaluation of the entered digit. For example, the call processor 28 may replace seemingly correct numbers with a ‘0’ and seemingly incorrect numbers with a ‘1’, eg. “7” is clearly incorrect when received as the first digit for a four-digit expiry year and is therefore replaced with a ‘1’.
a check digit may be provided, calculated from the received sensitive information, eg. a Luhn check for payment card data numbers

Such modifications to the RTPEVENT stream may allow for agent 2 to identify incorrect elements of the sensitive information without being privy to the sensitive data.

Call processor 28 may also increase security further by removing any ‘DTMF bleed’ present in the RTP (audio) stream, for example in accordance with the methods described in W02018172771.

FIG. 10 (i) shows, at 418, ODC 24 instructing call processor 28 to cease media forwarding and data switch 16 to revert to the original packet forwarding rules so that data streams are no longer forwarded to call processor 28, thereby exiting ‘secure mode’.

This may be may be determined by a further trigger signal being entered by the caller 2 and/or the agent 4, or by call processor 28, ODC 24 or DPM 26 determining that the entirety of the sensitive information required has been received.

FIG. 10 (j) shows, at 420, call processing system 8-3 having reverted to monitoring mode, with the data switch 16 mirroring only the SIP and RTPEVENT data streams to ODC 24 and the call processor 28 having returned to being a passive component of the call processing system.

Further Modifications and Other Alternatives

It will be understood that the present invention has been described above purely by way of example, and modifications of detail can be made within the scope of the invention.

Various embodiments may include one or more of the following features:

Only a portion of the sensitive information provided by caller 2 may be blocked from the agent 4. For example, agent 4 may receive the first n digits of a payment card number, where n is sufficient to identify the card issuer and in turn the expected length of the security code for the card.

Call processor 22, 28 and/or data switch 16 as instructed by ODC 24 may block the RTP and/or the RTPEVENT streams from passing to the merchant PBX 20, for example for the duration of entry of sensitive information.

In an alternative embodiment, the request for ‘secure mode’ is sent to ODC 24 by merchant PBX/ACD 20 or merchant SBC 18. The request includes the necessary information to allow the relevant call data streams to be re-routed to the call processor 28. This may remove the requirement for mirroring of the RTP and/or RTPEVENT streams to the ODC 24

As mentioned, the principles described above in respect of SIP calls, comprising three call data streams (SIP, RTP, and RTPEVENT), may be applied more broadly. For example, there may be only a single call data (audio) stream, where sensitive information is extracted from the audio stream based on the identification of DTMF tones, which are prevented from reaching the agent.

The principles may also be applied to other forms of agent-assisted interaction between a ‘caller’ and agent, for example, as provided during instant message (IM) chat sessions. Functions of the call processing system may be replicated by a chat processing system, including equivalents of ‘call’ (chat) processor which, when triggered acts to prevent the agent receiving sensitive information entered by the ‘caller’.

Data switch 16 may be implemented in hardware or software, including for example routing data between software applications on a single computer.

In an alternative embodiment of the secure-on-demand call processing system, no initial mirroring of call data streams to ODC 24 occurs and instead ODC 24 requests all calls to be routed via the call processor 20. Alternatively, only a subset of calls may be re-routed.

FIG. 11 shows an alternative secure call processing system, wherein triggering of ‘secure mode’ is based on the SIP stream only and does not require mirroring of the RTP or RTPEVENT streams to ODC 24. A parameter from the SIP signalling (such as the call ID or any other unique information in the SIP messaging) is used to identify which call is required to be placed into ‘secure mode’. This may be done by ODC 24, DPM 26 or by a dedicated Call

Identification Unit (CIU) 30 which communicates, for example using CTI, via a data interface with ODC 24, either directly or via DPM 26, indicating that a specific phone call (eg. on the basis of SIP call ID) should be placed into ‘secure mode’, so that the ODC 24 can accordingly instruct the call processor 24 and forward new packet forwarding rules to data switch 16. RTP and RTPEVENT streams are then passed via call processor 28 as described above.

CIU 30 is typically an existing, off-the-shelf CTI system, as commonly used in contact centres, adapted to receive notifications of call events (eg. new call started, call connected to agent, call transferred, etc.) from the merchant ACD/PBX 20. CIU 30 is therefore aware of the relationship between the SIP call ID and the ID of the agent 4 handling the call for every call.

This allows for the decision to enter ‘secure mode’ to be taken by the agent 4, either explicitly or inferred from agent actions. without needing to monitor for DTMF tones. For example, a request from a particular agent ‘1234’ for ‘secure mode’ would be translated by the CIU 30 into a request to place the call with SIP call ID 1 a2b3c4d′ into ‘secure mode’, without any need for the agent to use DTMF tones.

As described in the embodiments above, data switch 16 mirrors the RTPEVENT stream from merchant PBX 20 only after it has first passed via the merchant SBC 18. In some alternative embodiments data switch 16 mirrors the RTPEVENT stream from merchant PBX 20 directly when first received from merchant PBX 20.

Generally, mirroring of the data streams may be done at any point where they pass through the data switch 16; however, issues specific to particular implementations may mean it is more appropriate to monitor and to mirror at one interface in preference to another.

In practice, because the merchant SBC 18 would normally be expected to be performing “topology hiding” (changing IP addresses and ports; rewriting headers) as part of its security function, mirroring is likely to be done at the same point for both SIP and RTP/RTPEVENT streams.

Regarding aspects and embodiments of the invention set out in the appended claims, any reference numerals appearing in the claims are by way of illustration only and shall have no limiting effect on the scope of the claims.

1. A method of processing a communication or call between a first entity and a second entity, the method comprising:
routing call data between the first entity and the second entity;
monitoring for a trigger signal; and
upon detecting the trigger signal, routing the call data via a call processor adapted to process the call data for sensitive information received from the first entity.

2. The method of claim 1, further comprising routing the processed call data absent the sensitive information to the second entity.

3. The method of claim 1, wherein the call comprises a plurality of data streams and monitoring for a trigger signal comprises mirroring at least one data stream in which a trigger signal may be encoded to a controller.

4. The method of claim 2, further comprising modifying the routing of at least one data stream of the plurality of data streams according to a routing instruction received from the controller detecting the trigger signal.

5. The method claim 1, wherein the trigger signal is received from the second entity.

6. The method of claim 1, wherein the trigger signal is received from the first entity or a third entity monitoring the call.

7. The method of claim 6, wherein the trigger signal comprises at least one of: a call identifier, a call parameter or the sensitive information.

8. The method of claim 1, further comprising interacting with an external entity in dependence on the sensitive information.

9. The method of claim 1, further comprising reverting to routing the call data to the second entity once the encoded information has been received from the first entity.

10. The method of claim 3, wherein the telephone call comprises a SIP call and the data streams comprise SIP, RTP and RTPEVENT streams, preferably wherein mirroring at least one data stream comprises mirroring the RTP and/or RTPEVENT stream.

11. A call processing system for processing a communication or call between a first entity and a second entity, the system comprising:
a data switch, adapted to route call data between the first entity and the second entity;
a controller, adapted to monitor for a trigger signal and upon detecting the trigger signal to instruct the data switch to route the call data via a call processor; and
a call processor, adapted to process the call data for sensitive information received from the first entity.

12. The call processing system of claim 11, adapted to route the processed call data absent the sensitive information to the second entity.

13. The call processing system of claim 11, wherein the call comprises a plurality of data streams and the data switch is adapted to mirror at least one data stream in which a trigger signal may be encoded to the controller.

14. The call processing system of claim 13, wherein the controller is adapted to issue a routing instruction in response to detecting the trigger signal and the data switch is adapted to modify the routing of at least one data stream of the plurality of data streams in accordance with the routing instruction.

15. The call processing system of claim 11, wherein the controller is adapted to receive the trigger signal from the second entity.

16. The call processing system of claim 11, wherein the controller is adapted to receive the trigger signal from the first entity or a third entity adapted to monitor the call.

17. The call processing system of claim 16, wherein the trigger signal comprises at least one of: a call identifier, a call parameter or the sensitive information.

18. The call processing system of claim 11, adapted to interact with an external entity in dependence on the sensitive information.

19. The call processing system of claim 11, further adapted to revert to routing the call data to the second entity once the sensitive information has been received from the first entity.

20. The call processing system of claim 11 wherein the telephone call comprises a SIP call and the data streams comprise SIP, RTP and RTPEVENT streams, preferably wherein the data switch is adapted to mirror the RTP and/or RTPEVENT stream to the controller.
